(19) United States
(12) Patent Application Publication
(10) Pub. No.: US 2014/0129739 A1
(43) Pub. Date: May 8, 2014

(54) Dual Mobile Device Apparatus

(71) Applicant: Richard King, Chino Hills, CA (US)

(72) Inventor: Richard King, Chino Hills, CA (US)

(21) Appl. No.: 13/672,555

(22) Filed: Nov. 8, 2012

(51) Int. Cl. G06F 13/10

(52) U.S. Cl. CPC G06F 13/10
USPC 710/8

(57) ABSTRACT

A dual mobile device apparatus comprising a first mobile device running a first operating system and a second mobile device running a second operating system. Both mobile devices being mechanically coupled together with a connection such as a hinge allowing the said mobile devices to be positioned side by side or on top of one another. A means for facilitating communication between the first and second mobile devices and enabling selective data exchange therebetween.

### INCORPORATION BY REFERENCE

Applicant(s) hereby incorporate herein by reference any and all U.S. patents and U.S. patent applications cited or referred to in this application.

### BACKGROUND OF THE INVENTION

1. Field of the Invention

Aspects of this invention relate generally to dual display mobile devices and more particularly, to mobile devices which dual displays are coupled and that have the ability to run different software operating systems.

2. Description of Related Art

The following art defines the present state of this field:

Currently there are no known dual display mobile devices that are coupled and that have the ability to run different software operating systems for such exemplary embodiments like mobile phones or tablets. A variety of dual display mobile devices exists but do not offer a solution to a user that desires access to two different software operating systems whereby resulting in the user having the benefited of operating two different devices in one unit. Aspects of the present invention fulfill these needs and provide further related advantages as described in the following summary.

### SUMMARY OF THE INVENTION

Modernly, there exists a wide range of mobile devices including smartphones and tablets. These devices are popular because they allow people to perform multiple activities with their digital devices including work related functions and also personal leisure activities such as watching movies, listening to music, reading books etc . . . . Each digital device includes its own operating software which allows users to the ability to operate the device and to add existing applications or “apps” that function with the particular operating system of that device. There are also many formats of digital devices with some smartphones containing keyboards while others are just touchscreens or a combination of both. Often times however, users are forced to choose between different digital devices because certain operating systems provide different functionality and also provide different access to certain applications that are only native to a certain type of software operating system. In addition, users are also often required to choose a physical format (e.g. keyboard or touchscreen) when selecting a digital device preventing them from having the option of accessing more than one physical format.

Aspects of the present invention teach certain benefits in construction and use which give rise to the exemplary advantages described below.

In an exemplary embodiment of the invention, a dual mobile device apparatus comprising a first display and second display, first mobile device running a first operating system; a second mobile device running a second operating system; said second operating system being different from that of the first operating system and at least one coupling mechanism allowing the dual mobile device apparatus to be selectively oriented between an open and closed state and a means for facilitating communication and data exchange between the first and second operating systems.

A primary objective inherent in the above-described apparatus and method of use is to provide advantages not taught by the prior art.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary embodiment of the invention in a side by side open position;

FIG. 2 is a perspective view of an exemplary embodiment of the invention in a semi-folded position;

FIG. 3 is a top view of an exemplary embodiment of the invention in a side by side open position;

FIG. 4 is a top view of an exemplary embodiment of the invention in a closed position;

FIG. 5 is a perspective view of the exemplary embodiment in a closed position;

FIG. 6 is a perspective view of the exemplary alternate embodiment in an open position;

FIG. 7 is a back view of the exemplary alternate embodiment in an open position;

FIG. 8 is a view of the exemplary embodiment in a closed position depicting both displays folded on top of one another;

FIG. 9 is another view of the exemplary embodiment in a closed position depicting both displays folded on top of one another;

FIG. 10 is another view of the exemplary embodiment in an open position depicting both displays folded on top of one another with an alternative embodiment of the hinge coupling;

FIG. 11 is another view of the exemplary embodiment in a closed position depicting both displays folded on top of one another with an alternative embodiment of the hinge coupling;

FIG. 12 is view of the exemplary embodiment in an open position depicting both displays folded on top of one another with an alternative embodiment of the hinge coupling;

FIG. 13 is another view of the exemplary embodiment in a closed position depicting both displays folded on top of one another with an alternative embodiment of the hinge coupling;

FIG. 14 is another view of the exemplary embodiment in a closed position depicting both displays folded on top of one another with an alternative embodiment of the hinge coupling;

FIG. 15 is a view of the exemplary embodiment in a closed position depicting a dual mobile device apparatus having a means for facilitating communication between the first and second mobile devices and enabling selective data exchange therebetween.

Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

Broadly, aspects of the present invention generally relate to a dual mobile device apparatus containing dual displays with the ability to run at least one software operating system. The dual displays are coupled by a hinge which allows the user the ability to use both displays during operation. Additionally, the dual mobile device apparatus contains means for facilitating communication between the first and second mobile device whereby enabling data exchange therebetween. In one embodiment, the present invention contains two mobile smartphones as the dual mobile devices with each running a different software operating system. In another embodiment, the present invention contains two tablets as the dual mobile devices with each running a different software operating system.

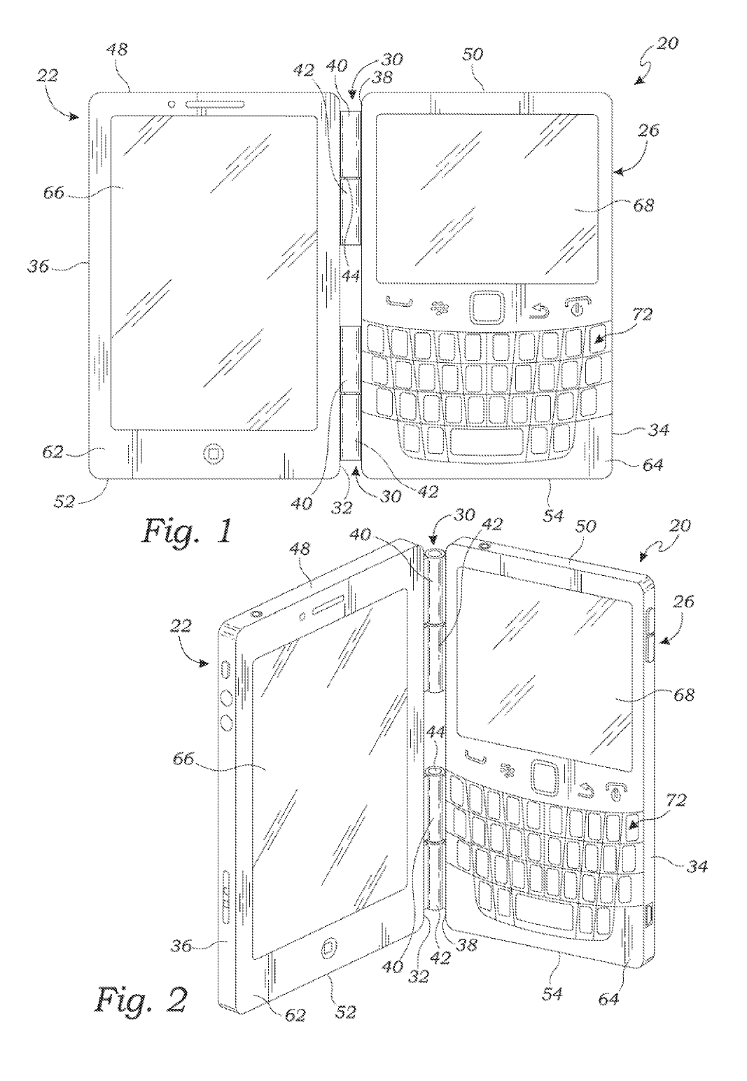

Turning now to FIG. 1, there is shown a perspective view of an exemplary embodiment of a dual mobile device apparatus 20 in a side by side open position and in FIG. 2 there is the same embodiment of a dual mobile device apparatus 20 in a side by side semi-folded position. As can be seen, the dual mobile device apparatus 20 comprises, in the exemplary embodiment, a first mobile device 22, a second mobile device 26, a hinge 30, a left edge (first device) 32, a left edge (second device) 34, a right edge (first device) 36, a right edge (second device) 38, a first barrel 40, a second barrel 42, a pin 44, an axis 46, a top edge (first device) 48, a top edge (second device) 50, a bottom edge (first device) 52, a bottom edge (second device) 54, the front surface (first device) 62, and the front surface (second device) 64, a first display 66, a second display 68. As clearly seen, in this exemplary embodiment, the dual mobile device apparatus 20 can be in the form of two wireless mobile phones, one a touchscreen device and the other containing a full featuring QWERTY keyboard 72. FIG. 2 shows the same exemplary embodiment as seen in FIG. 1 but in a semi-folded position.

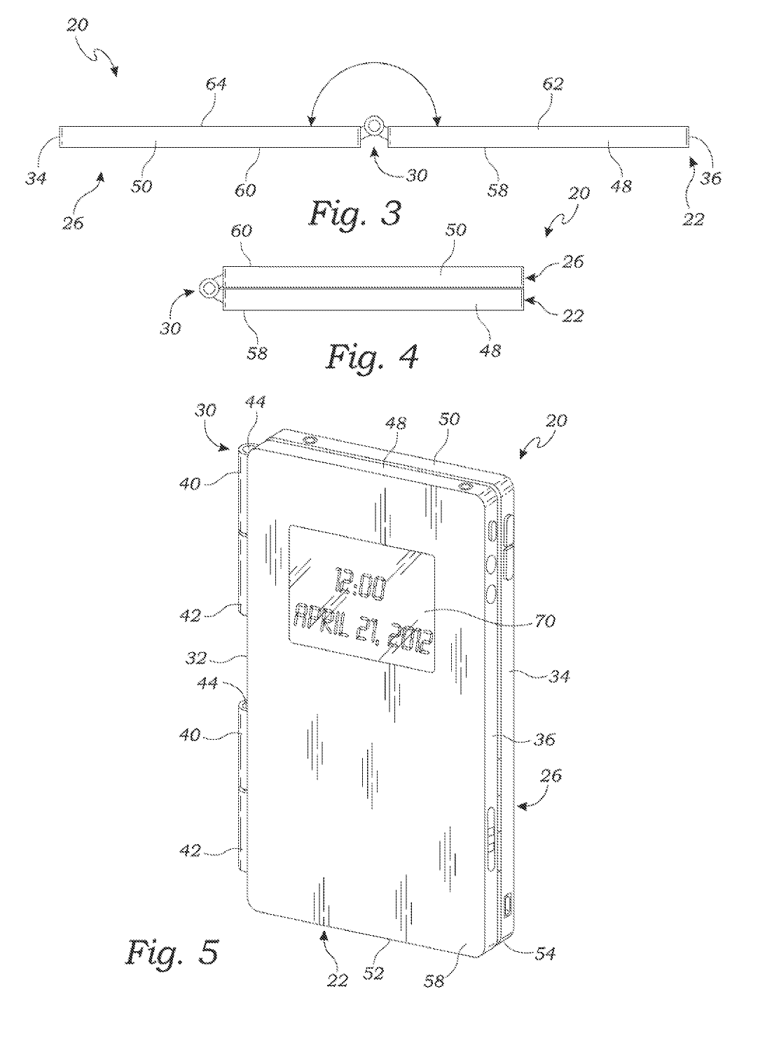

With continued reference to FIG. 3, the top down view of the exemplary embodiment of the dual mobile device apparatus 20 is seen in a side by side open position whereby providing the user the ability to use the first mobile device 22 and second mobile device's 26 displays (66, 68) simultaneously. In contrast, FIG. 4 depicts a top down view of the dual mobile device apparatus in a closed position whereby both mobile devices are folded on top of one another. In this exemplary embodiment, the first mobile device 22 and second mobile device's 26 displays (66, 68) are top of each other whereby exposing the rear surfaces (58, 60) of both mobile devices (22, 26). In one preferred exemplary embodiment, both sizes of the mobile devices (22, 26) are the same size dimensions to allow both the edges of the tops and sides of the mobile devices (22, 26) to be flush with each other when at a closed position. FIG. 5 shows another perspective view of the dual mobile device apparatus 20 as seen in FIG. 4. As seen in FIG. 5, in this exemplary embodiment, the rear surfaces (58) (60) are exposed on the outside whereas the front surfaces (62, 64), including both displays (66, 68) are positioned on the inside and un-exposed. In practical use, a user would typically use this exemplary embodiment when it is desirable to protect the display surfaces (66, 68) from being damaged when not in use. In one exemplary embodiment, at least one of the rear surfaces may contain a small display 70 which still allows the user to obtain important information such as time and date without having to open or expose both displays (66, 68).

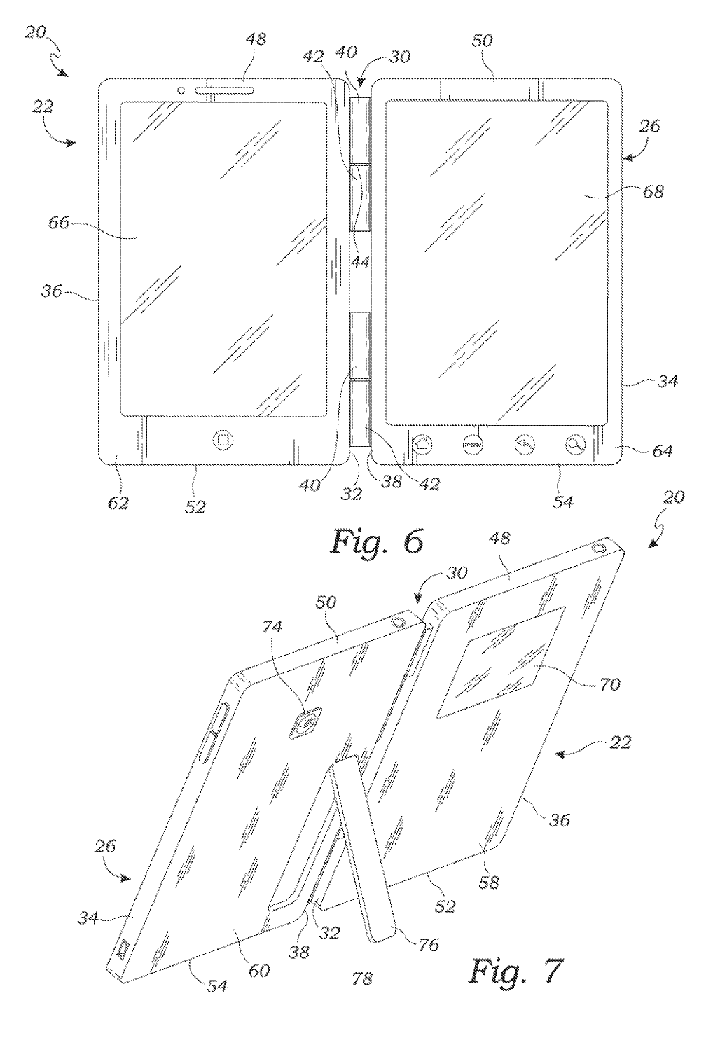

As seen in FIG. 6, the dual mobile device apparatus 20 in another preferred embodiment can comprise of dual mobile devices in the form of dual touchscreen tablets (66, 68). As shown in FIG. 6, each mobile device can be a different product as evidenced by the difference in the front surface 62 of the first device and front surface of the second device 64. Turning to FIG. 7, in one embodiment, the rear sides of the dual mobile devices can contain a rear display 70 in order to display certain user information. In one preferred embodiment, the rear of the first device 58 can contain a kickstand 76 while the rear of the second device 60 may contain a rear display 70 to provide information. The kickstand 76 would allow the dual mobile device 20 to rest on a surface 78 and be propped up to allow for convenient hands-free viewing and reading. In one exemplary embodiment, at least one of the rear surfaces (58, 60) may contain a camera and/or camera lens 74 to allow the user to take photographs and video.

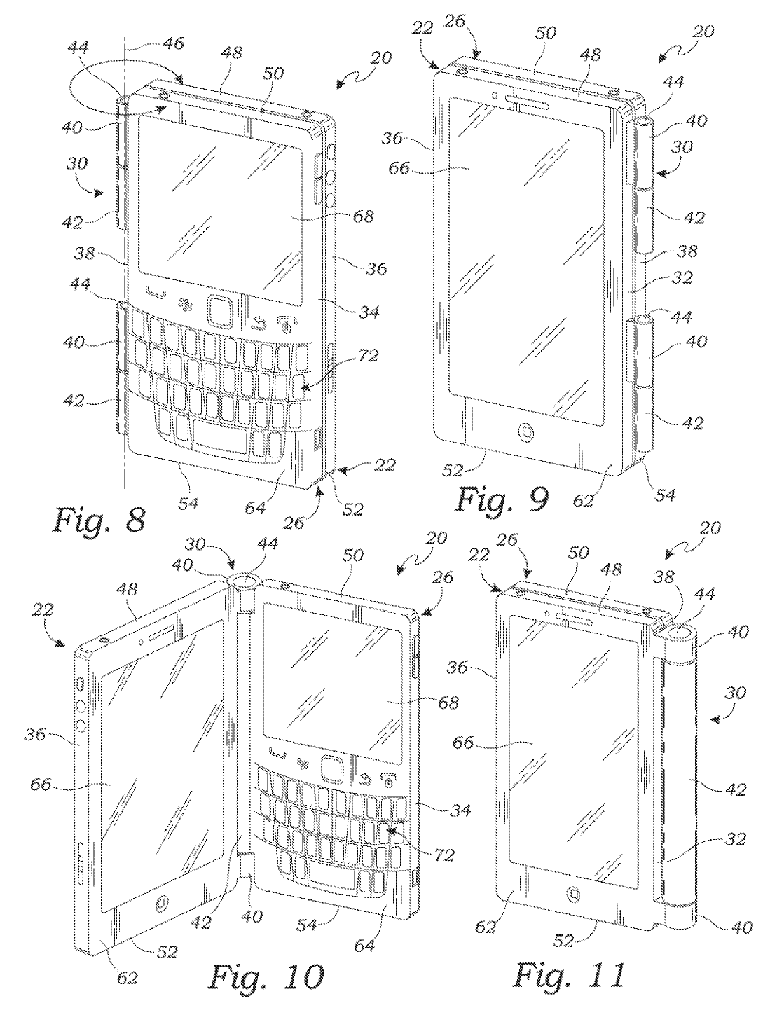

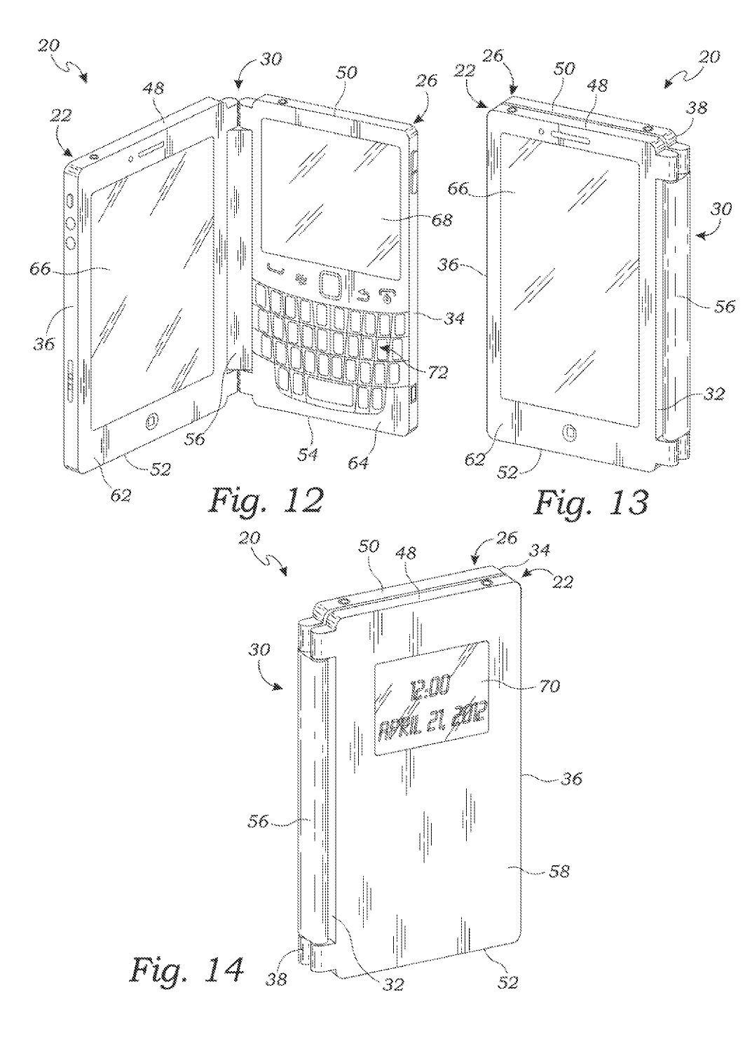

FIGS. 8 and 9 show a perspective view of an exemplary embodiment of a dual mobile device apparatus 20 similar to FIG. 1 in a closed position with both dual mobile devices are folded on top of one another. This exemplary configuration allows the user the ability to use two totally different mobile devices in one compact unit. In one preferred embodiment, the first mobile device 22 may be in the form of a mobile phone with a standard QWERTY keyboard 72 for data entry purposes. The second mobile device 26 may be in the form of a touch-screen mobile phone 66. In this exemplary configuration both mobile devices are coupled by a hinge 30 which comprises a first barrel 40 and a second barrel 42 containing a pin 44 which extends through and securing together the first and second barrels (40, 42) together. The first barrel 40 is positioned proximal a top edge of the first mobile device 22 and a second one of the first barrels is positioned proximal a bottom edge of the first mobile device and said barrels positioned for receiving the second barrel therebetween. The hinge 30 in this exemplary embodiment allows the first device 22 and second device 26 to freely rotate to have the first mobile device 22 and second mobile device 26 in multiple positions including side by side, semi-folded, folded on top of one another where both displays (66, 68) are showing or folded on top of one another where both rear surfaces (58, 60) are showing. FIGS. 10 and 11 depict a perspective view of another exemplary embodiment of dual mobile device 20 similar to FIGS. 9 and 10 with another embodiment of the hinge 30, a first barrel 40, second barrel 42 and pin 44. Although in one present embodiment, the coupling mechanism for the first mobile device 22 and second mobile device 26 is a hinge 30, it should be appreciated that the coupling mechanism can be any type of coupling mechanism that will allow the first mobile device 22 and second mobile device 26 to rotate freely. FIGS. 12 and 13 provide yet another perspective view of another exemplary embodiment of a dual mobile device 20 similar to FIGS. 9 and 10 with another embodiment of the hinge 30, a first barrel 40, second barrel 42 and pin 44. In this exemplary embodiment, the hinge 30 includes a joining member 56 which may provide further support to the hinge 30 and provide more of a seamless aesthetic appearance. Each of the left edge of the first mobile device and the right edge of the second mobile device pivotally engaged with the joining member, allowing each of the first and second mobile devices to be selectively and independently pivoted relative to the joining member 56. As shown in FIG. 14, the exemplary embodiment shown in FIGS. 12 and 13 is in a closed position with the front surfaces (62, 64) of the first mobile device 22 and second mobile device 26 on top of each other exposing the rear surfaces (58, 60).

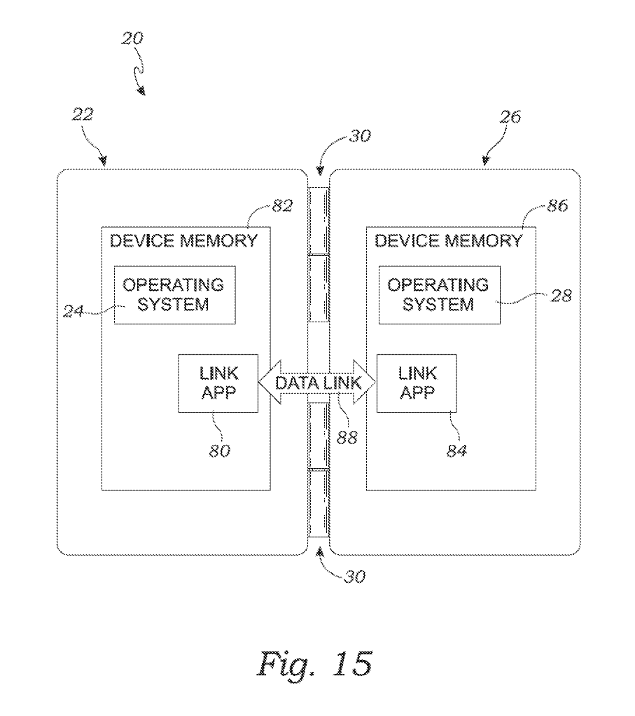

Another important feature of the present invention is the ability of the dual mobile device apparatus 20 to contain a means for facilitating communication between the first mobile device 22 and second mobile device 26 and enabling selective data exchange therebetween. Here as shown in FIG. 15, in one exemplary embodiment the dual mobile device apparatus 20 comprises a first application 80, memory on first device 82, a second application 84, memory on second device 86 and a data/information link 88. In one preferred exemplary embodiment, the first application 80 may be in the form of a software operating system for a particular mobile device and the second application 84 may be in the form of a different software operating system for another particular mobile device whereby allowing the user the ability to use/operate two separate mobile devices running two separate software operating systems in the one self-contained unit. In one preferred exemplary embodiment there exists a data/information link 88 that allows both software operating systems on both mobile devices to communicate with each other and share data/information. In one preferred embodiment, the data/information link 88 can be in the form of an mobile application that can be installed on both mobile devices which creates a direct link between the first and second mobile devices (22, 26) thereby enabling the selective exchange of data therebetween. In one exemplary embodiment, the data/information link 88 in the form of a mobile application resides in memory 82 on the first mobile device 22 and memory 86 on the second mobile device 26.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A dual mobile device apparatus comprising:
a first mobile device running a first operating system;
a second mobile device running a second operating system, said second operating system being different from that of the first operating system;
only a single barrel hinge, disposed entirely between horizontal planes defined by a top edge and a bottom edge of the first mobile device, the barrel hinge rotating about a single axis allowing more than 180 degrees of motion between the first and second mobile devices, and joining the first and second mobile devices, allowing said mobile devices to be selectively oriented between an open state, wherein said mobile devices are positioned side by side, and a closed state, wherein said mobile devices are folded flat against one another; and
a means for facilitating communication between the first and second mobile devices and enabling selective data exchange therebetween.

2. The apparatus of claim 1, wherein the barrel hinge is integral with a left edge of the first mobile device and a right edge of the second mobile device.

3. The apparatus of claim 2, wherein the barrel hinge comprises:
an at least one first barrel integral with the left edge of the first mobile device;
an at least one second barrel integral with the right edge of the second mobile device; and
an at least one pin extending through and securing together the first and second barrels, said barrels selectively pivotable about a common axis created by the pin.

4. The apparatus of claim 3, wherein a first one of the first barrels is positioned proximal the top edge of the first mobile device and a second one of the first barrels is positioned proximal the bottom edge of the first mobile device, said first barrels positioned for receiving the second barrel therebetween.

5. The apparatus of claim 2, wherein the barrel hinge comprises:
a joining member; and
each of the left edge of the first mobile device and the right edge of the second mobile device pivotally engaged with the joining member, allowing each of the first and second mobile devices to be selectively and independently pivoted relative to the joining member;
whereby, the first and second mobile devices are capable of being selectively oriented between an open state, wherein said mobile devices are positioned side by side, a first closed state, wherein said mobile devices are folded on top of one another with a rear surface of each mobile device in abutting contact, and a second closed state, wherein said mobile devices are folded on top of one another with a front surface of each mobile device in abutting contact.

6. The apparatus of claim 1, wherein the barrel hinge is integral with the bottom edge of the first mobile device and a top edge of the second mobile device.

7. The apparatus of claim 1, wherein a front surface of the first mobile device provides a first display, and a front surface of the second mobile device provides a second display.

8. The apparatus of claim 1, wherein at least one of the first and second displays is a touchscreen.

9. The apparatus of claim 1, wherein a rear surface of at least one of the mobile devices provides an at least one rear display.

10. The apparatus of claim 1, wherein a front surface of at least one of the mobile devices provides a physical keyboard.

11. The apparatus of claim 1, wherein a rear surface of at least one of the mobile devices provides an at least one camera lens.

12. The apparatus of claim 1, wherein a rear surface of at least one of the mobile devices provides an at least one kickstand positioned and configured for maintaining the apparatus in a substantially vertical position when placed on a surface.

13. The apparatus of claim 1, wherein the means for facilitating communication between the first and second mobile devices comprises:
a first application residing in memory on the first mobile device;
a second application residing in memory on the second mobile device;
the first and second applications in communication with one another for creating a direct link between the first and second mobile devices, thereby enabling the selective exchange of data therebetween.

14. The apparatus of claim 1, wherein at least one of the mobile devices is a smartphone.

15. The apparatus of claim 1, wherein at least one of the mobile devices is a tablet computing device.

16. A dual mobile device apparatus comprising:
a first mobile device running a first operating system;
a second mobile device running a second operating system, said second operating system being different from that of the first operating system;
only a single barrel hinge, disposed entirely between horizontal planes defined by a top edge and a bottom edge of the first mobile device, the barrel hinge rotating about a single axis allowing more than 180 degrees of motion between the first and second mobile devices, and joining the first and second mobile devices, allowing said mobile devices to be selectively oriented between an open state, wherein said mobile devices are positioned side by side, and a closed state, wherein said mobile devices are folded flat against one another;
a first application residing in memory on the first mobile device; and
a second application residing in memory on the second mobile device;
the first and second applications in communication with one another for creating a direct link between the first and second mobile devices, thereby enabling the selective exchange of data therebetween.

17. A dual mobile device apparatus comprising:
a first mobile device running a first operating system;
a second mobile device running a second operating system, said second operating system being different from that of the first operating system;
only a single barrel hinge, disposed entirely between horizontal planes defined by a top edge and a bottom edge of the first mobile device, the barrel hinge rotating about a single axis allowing more than 180 degrees of motion between the first and second mobile devices, and in pivotal engagement with each of the first and second mobile devices, allowing each of the first and second mobile devices to be selectively and independently pivoted, relative to the barrel hinge, between an open state, wherein said mobile devices are positioned side by side, a first closed state, wherein said mobile devices are folded on top of one another with a rear surface of each mobile device in abutting contact, and a second closed state, wherein said mobile devices are folded flat against one another with a front surface of each mobile device in abutting contact; and
a means for facilitating communication between the first and second mobile devices and enabling selective data exchange therebetween.
